(19) United States
(12) Patent Application Publication
(10) Pub. No.: US 2012/0055970 A1
(43) Pub. Date: Mar. 8, 2012

(54) Auto-Breaking Machine

(75) Inventors: Chi-Hsing Chang, Taipei (TW); Feng-Chi Lee, Taipei (TW); Kuo-Chuan Chiu, Taipei (TW); Chien-Ju Hua, Taipei (TW)

(73) Assignee: CHENG UEI PRECISION INDUSTRY CO., LTD., Taipei (TW)

(21) Appl. No.: 12/874,641

(22) Filed: Sep. 2, 2010

(51) Int. Cl. B26F 3/00

(52) U.S. Cl. 225/93

(57) ABSTRACT

An auto-breaking machine for breaking a base band from terminals of a connector includes a positioning assembly positioning the connector, a feeding assembly driving the positioning assembly to deliver the connector, and a breaking assembly including a motor, an adjusting part connected with the motor, a drive member fastened to the adjusting part and having a front defined as a drive post with an adjustable offset distance between the axis thereof and that of the motor, a slider slidably mounted to a support holder and defining a window having a height corresponding to the diameter of the drive post, and a breaking part fastened on the slider. The drive post is inserted in the window to drive the slider to slide up and down via the turn thereof and further drive the breaking part to move up and down so as to break off the base band from the terminals.

### BACKGROUND OF THE INVENTION

1. Field of the Invention

The present invention relates to a breaking machine, and more particularly to an auto-breaking machine adapted for breaking off a base band from terminals.

2. The Related Art

A conventional electrical connector includes an insulating housing and a plurality of terminals disposed in the insulating housing. Generally, the terminals are firstly formed at a side edge of a base band and arranged at regular intervals along the side edge of the base band so as to be conveniently and efficiently assembled in the insulating housing. The base band stretches behind the insulating housing and then is broken off from the terminals by a breaking machine.

The breaking machine includes a feeding assembly, a positioning assembly fastened to one end of the feeding assembly for positioning the electrical connector, and a breaking assembly which includes a cylinder, a slider and a breaking part fastened on the slider. The cylinder can drive the slider to slide up and down, and further drive the breaking part to move up and down. In use, the electrical connector is positioned in the positioning assembly and then carried to a preset position by the feeding assembly, so as to make the base band be broken off from the terminals by means of the up-and-down movement of the breaking part under the drive of the cylinder. However, it is difficult to adjust the move range of the breaking part in the vertical direction driven by the cylinder. Furthermore, the cylinder has a high noise on account of sharp shock thereof, which results in a low stability of the breaking machine during working

### SUMMARY OF THE INVENTION

An object of the present invention is to provide an auto-breaking machine adapted for breaking a base band from terminals of an electrical connector, wherein the terminals are connected with a side edge of the base band. The auto-breaking machine includes a positioning assembly for positioning the electrical connector with the base band stretching behind the positioning assembly, a feeding assembly connected with the positioning assembly for driving the positioning assembly to deliver the electrical connector towards a breaking assembly, and the breaking assembly which includes a motor, an adjusting part connected with the motor, a drive member fastened to the adjusting part and having a front defined as a drive post, a support holder located in front of the motor, a slider vertically slidably mounted to a front face of the support holder, and a breaking part fastened on the slider. The drive member is fastened to the adjusting part with an adjustable offset distance formed between axes of the drive post and the motor so as to be driven by the motor to turn around the axis of the motor. A window is opened in the slider and has a height corresponding to the diameter of the drive post. The drive post projects in front of the support holder and is inserted in the window of the slider to drive the slider to slide up and down by means of the turn thereof and further drive the breaking part to move up and down so as to break off the base band from the terminals.

As described above, the auto-breaking machine of the present invention can efficiently break off the base band from the terminals by means of the breaking assembly, because the slide range of the breaking part can be altered by means of adjusting the offset distance between the axes of the drive post and the motor. So the auto-breaking machine not only can meet different demands of various base bands, but also has a higher stability and a lower noise during working.

### BRIEF DESCRIPTION OF THE DRAWINGS

The present invention will be apparent to those skilled in the art by reading the following description, with reference to the attached drawings, in which:

FIG. 1 is a perspective view of an auto-breaking machine in accordance with an embodiment of the present invention;

FIG. 2 is an exploded view of a breaking assembly of the auto-breaking machine of FIG. 1;

FIG. 3 shows a relationship between axes of a drive post and a motor of the breaking assembly;

FIG. 4 is a perspective view of an electrical connector with a base band; and

FIG. 5 is an exploded view of the electrical connector of FIG. 4.

### DETAILED DESCRIPTION OF THE PREFERRED EMBODIMENT

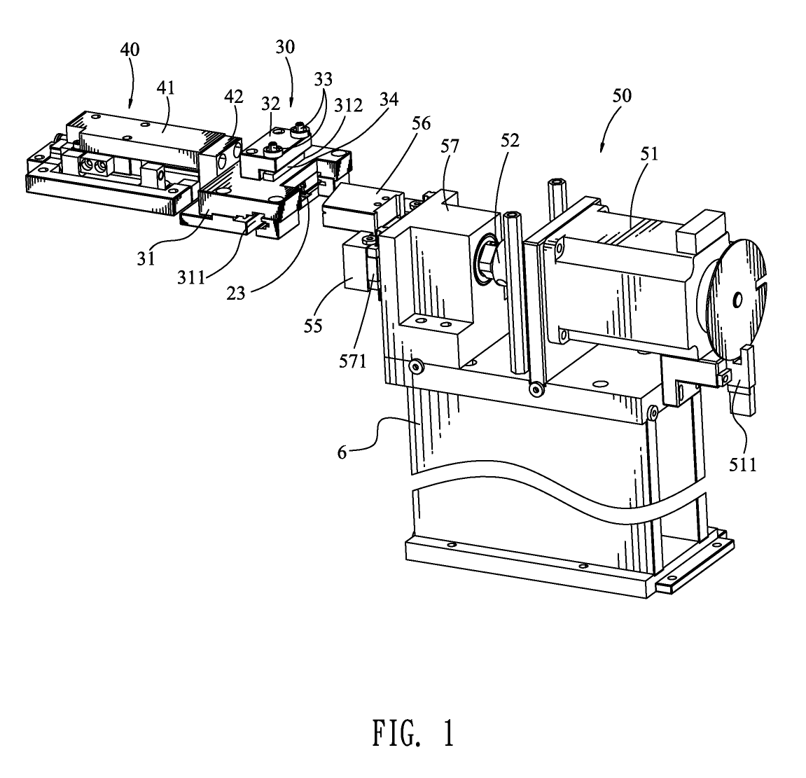

Referring to FIG. 1, FIG. 4 and FIG. 5, an auto-breaking machine in accordance with the present invention is adapted for breaking off a base band 23 from a plurality of terminals 22 of an electrical connector 2, wherein the terminals 22 are formed at a side edge of the base band 23 and arranged at regular intervals along the side edge of the base band 23. The electrical connector 2 further includes an insulating housing 21 in which the terminals 22 are disposed, with the base band 23 stretching behind the insulating housing 21. The auto-breaking machine includes a positioning assembly 30, a feeding assembly 40 and a breaking assembly 50.

Referring to FIG. 1 again, the feeding assembly 40 includes a cylinder (not shown), a feeding slider 41 capable of moving to and fro along a front-to-rear direction by means of the drive of the cylinder, and a connecting part 42. The positioning assembly 30 includes a positioning body 31 and a fixing block 32 fixed on a top of the positioning body 31. The connecting part 42 is connected between the feeding slider 41 and the positioning body 31 so as to make the movement of the feeding slider 41 drive the positioning body 31 to move along the front-to-rear direction. A positioning cavity 311 is opened in a bottom of the positioning body 31 and penetrates through two opposite sides of the positioning body 31 by extending along a direction perpendicular to the movement direction of the positioning body 31. A middle of the positioning cavity 311 on one hand penetrates through a rear surface of the positioning body 31, and on the other hand further extends upward to form a receiving passage 312 which passes through the top of the positioning body 31 and is located under the fixing block 32. Two elastic elements 33 are vertically telescopically mounted in the fixing block 32 and spaced from each other, with bottom ends stretching into the receiving passage 312. A positioning board 34 is movably inserted in the receiving passage 312, with a top end abutting against the bottom ends of the elastic elements 33. In use, the electrical connector 2 is positioned in the positioning cavity 311 and the base band 23 stretches out of the rear surface of the positioning body 31. Then the elastic elements 33 press the positioning board 34 downward to make the positioning board 34 move downward so as to firmly secure the electrical connector 2 in the positioning cavity 311.

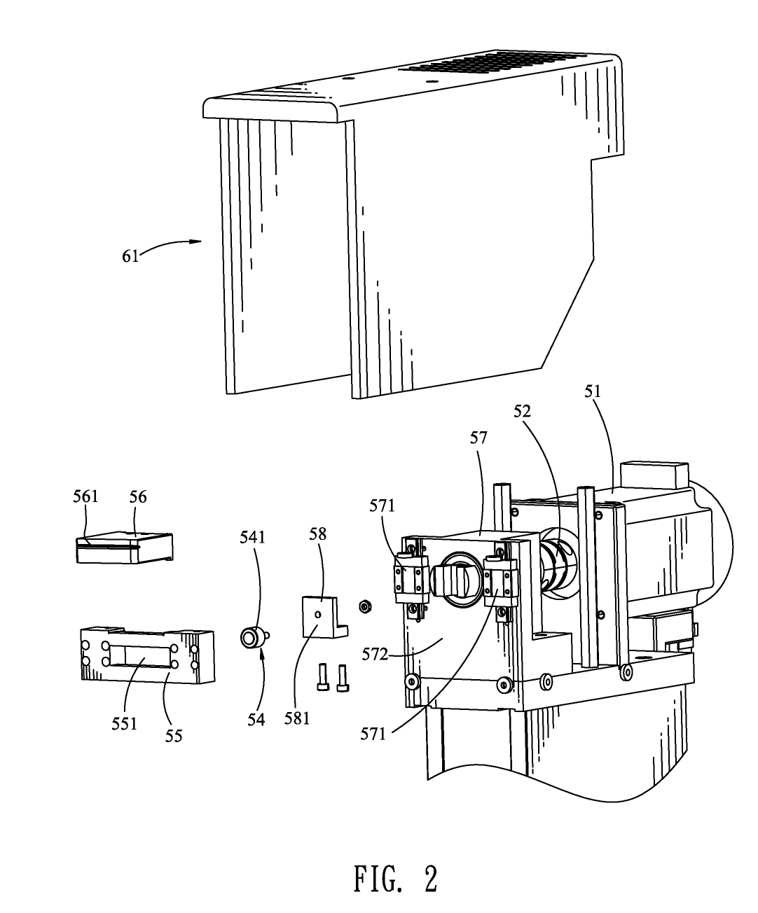

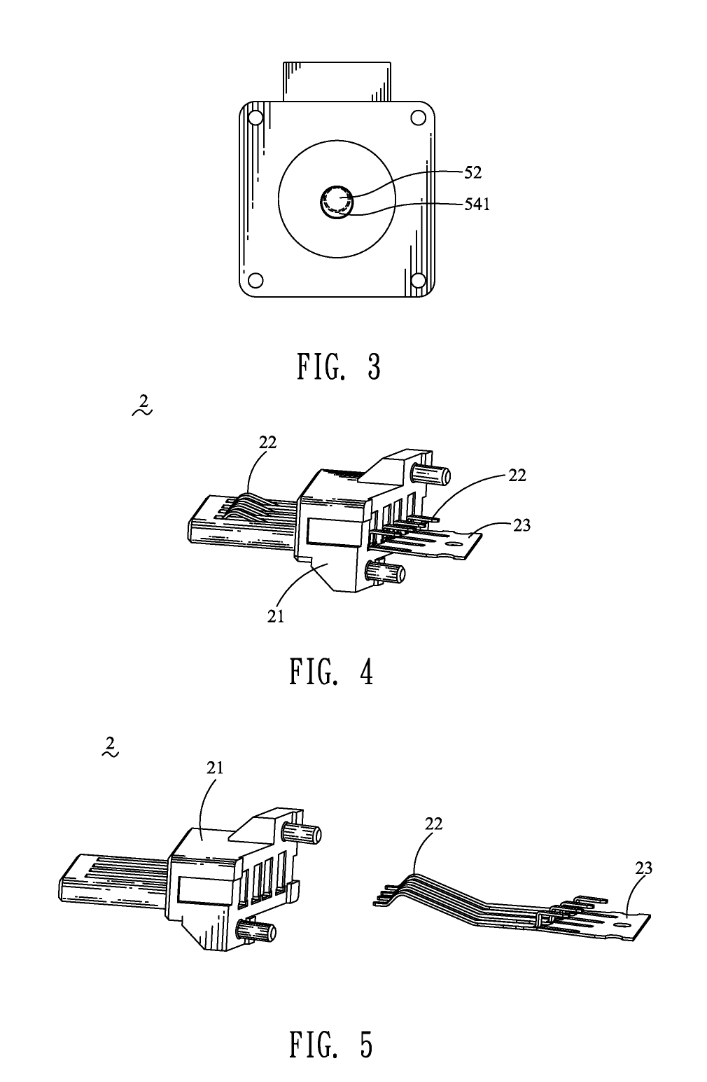

Referring to FIG. 1, FIG. 2 and FIG. 3, the breaking assembly 50 includes a motor 51, a drive shaft 52 of which a rear end is connected with the motor 51 and a front end penetrates through a support holder 57 to be connected with an adjusting part 58, a drive member 54 fastened at a front surface 581 of the adjusting part 58, a slider 55 having a rectangular window 551 opened therein, and a breaking part 56, wherein the motor 51 and the support holder 57 are mounted on a support frame 6. A portion of the drive member 54 stretching out of the front surface 581 of the adjusting part 58 is of column shape and defined as a drive post 541 having an offset distance between an axis thereof and that of the drive shaft 52. A pair of sliding tracks 571 is mounted on a front face 572 of the support holder 57 and vertically located at two opposite sides of the adjusting part 58. The slider 55 is slidably mounted to the sliding tracks 571 and the drive post 541 is inserted in the window 551, wherein the diameter of the drive post 541 is corresponding to the height of the window 551 and shorter than the transverse length of the window 551. So the slider 55 can be driven by the drive post 541 to slide up and down along the sliding tracks 571, when the drive post 541 turns around the axis of the drive shaft 52 under the drive of the motor 51. The breaking part 56 is secured on the slider 55 and has a front end project beyond the slider 55. A clipping slot 561 extends along a direction perpendicular to the sliding direction of the slider 55, and is opened at the front end of the breaking part 56 to face the middle of the positioning cavity 311 for clipping the base band 23 therein. The breaking assembly 50 further includes a counter 511 connected with the motor 51 for setting spin revolutions of the motor 51 so as to meet different demands of various base bands 23, and a protecting shell 61 surrounding around the breaking assembly 50.

Referring to FIGS. 1-5, in use, the feeding slider 41 of the feeding assembly 40 delivers the electrical connector 2 towards the breaking part 56 under the drive of the cylinder of the feeding assembly 40 so as to make the base band 23 be clipped in the clipping slot 561 of the breaking part 56. Then the motor 51 drives the drive post 541 of the drive member 54 to turn around the axis of the drive shaft 52 so that further drives the breaking part 56 to slide up and down so as to break off the base band 23 from the terminals 22. The times of breaking off the base band 23 from the terminals 22, namely the spin revolutions of the motor 51, can be set by the counter 511 according to the joint strength of the base band 23 and the terminals 22. Furthermore, the slide range of the breaking part 56 in the vertical direction can be adjusted by means of adjusting the offset distance between the axis of the drive post 541 and the one of the drive shaft 52.

As described above, the auto-breaking machine of the present invention can efficiently break off the base band 23 from the terminals 22 by means of the breaking assembly 50, because the times of breaking off the base band 23 can be altered by means of adjusting the spin revolutions of the motor 51 with the counter 511 and the slide range of the breaking part 56 also can be altered by means of adjusting the offset distance between the axes of the drive post 541 and the drive shaft 52. So the auto-breaking machine not only can meet different demands of various base bands 23, but also has a higher stability and a lower noise during working

What is claimed is:

1. An auto-breaking machine adapted for breaking off a base band from terminals of an electrical connector, wherein the terminals are connected with a side edge of the base band, the auto-breaking machine comprising:
a positioning assembly for positioning the electrical connector with the base band stretching behind the positioning assembly;
a breaking assembly including a motor, an adjusting part connected with the motor, a drive member fastened to the adjusting part and having a front defined as a drive post, a support holder located in front of the motor, a slider vertically slidably mounted to a front face of the support holder, and a breaking part fastened on the slider, wherein the drive member is fastened to the adjusting part with an adjustable offset distance formed between axes of the drive post and the motor so as to be driven by the motor to turn around the axis of the motor, a window is opened in the slider and has a height corresponding to the diameter of the drive post, the drive post projects in front of the support holder and is inserted in the window of the slider to drive the slider to slide up and down by means of the turn thereof and further drive the breaking part to move up and down; and
a feeding assembly connected with the positioning assembly for driving the positioning assembly to deliver the electrical connector towards the breaking assembly so as to make the base band be broken off from the terminals by the up-and-down movement of the breaking part of the breaking assembly.

2. The auto-breaking machine as claimed in claim 1, wherein the window is of substantially rectangular shape and further has a greater length than the diameter of the drive post.

3. The auto-breaking machine as claimed in claim 1, wherein a drive shaft is connected between the motor and the adjusting part, and has the axis in alignment with that of the motor so as to be driven by the motor to revolve on its own axis and further drive the drive post to turn around the axis of the drive shaft, a front end of the drive shaft penetrates through the support holder.

4. The auto-breaking machine as claimed in claim 1, wherein a clipping slot extending along a direction perpendicular to the sliding direction of the slider is opened at a front end of the breaking part and faces the positioning assembly for clipping the base band therein.

5. The auto-breaking machine as claimed in claim 1, wherein the breaking assembly further includes a counter connected with the motor for setting spin revolutions of the motor and further adjusting the times of the breaking part breaking off the base band from the terminals.

6. The auto-breaking machine as claimed in claim 1, wherein a pair of sliding tracks is mounted on the front face of the support holder and vertically located at two opposite sides of the drive post of the drive member, the slider is slidably mounted to the sliding tracks.

7. The auto-breaking machine as claimed in claim 1, wherein the feeding assembly includes a cylinder, a feeding slider capable of moving to and fro along a front-to-rear direction by means of the drive of the cylinder, and a connecting part connecting with the feeding slider and the positioning assembly so as to drive the positioning assembly to move along the front-to-rear direction.

8. The auto-breaking machine as claimed in claim 1, wherein the positioning assembly includes a positioning body connected with the feeding assembly and a fixing block fixed on a top of the positioning body, a bottom of the positioning body defines a positioning cavity penetrating through a rear surface of the positioning body for positioning the electrical connector therein, a receiving passage extends vertically to be connected with the positioning cavity and is located under the fixing block for receiving a positioning board therein, two elastic elements are vertically telescopically mounted in the fixing block and further stretch into the receiving passage to press the positioning board downward so as to further restrain the electrical connector in the positioning cavity.
